(19) United States
(12) Patent Application Publication
(10) Pub. No.: US 2013/0027537 A1
(43) Pub. Date: Jan. 31, 2013

(54) CAR VIDEO RECORDER

(71) Applicant: Zhitao Li, Zhongshan City (CN)

(72) Inventor: Zhitao Li, Zhongshan City (CN)

(73) Assignee: STEELMATE CO., LTD., Zhongshan City (CN)

(21) Appl. No.: 13/640,184

(22) PCT Filed: May 19, 2011
(86) PCT No.: PCT/CN11/74309

§ 371 Date: Oct. 9, 2012

(30) Foreign Application Priority Data
Mar. 11, 2011 (CN) 201110059639.3

(51) Int. Cl. H04N 7/18

(52) U.S. Cl. 348/77; 348/E07.085

(57) ABSTRACT

A car video recorder includes a human body sensing device for generating a first signal when a person gets close to the device; an acceleration sensor for generating a second signal when it detects that an action is imposed on a car; a camera device for real time video recording; a control unit which detects whether the car starts; in case that the car flames out, if the control unit receives the first or second signal and the signal meets a predefined condition, then the control unit drives the camera device to automatically perform human body detection and human face recognition; after successful recognition, the control unit stores camera data as special data; and a memory at least including a first partition for storage of the special data therein. The car video recorder employs the microwave sensor and acceleration sensor and camera device cooperatively to realize the functions such as recognition of the human face, taking photos and video of the human face and safety transfer of the camera data carrying information related to the human face.

### FIELD OF THE INVENTION

The invention relates to a safety device for a car and more particularly, the invention relates to a car video recorder.

### BACKGROUND OF THE INVENTION

Currently there are two kinds of automobile safety devices. One is a conventional car safety system used for many years. This kind of safety system mostly serves the purposes of anti-theft and anti-collision. Another kind of car safety device is a car camera which begins work immediately after the start of the car and records the events happened during the whole driving period, and functions like a black box used in airplane. This kind of automobile safety device may help discern the party who should be responsible for the traffic accident.

With the development of mobile communication system and global positioning system, the car safety device is capable of addressing. However, this device has not yet been able to be cooperated with to find out the wreckers. Similarly the car camera is also insufficient in its function. The most serious disadvantage of this kind of device is failure of recording when the car flames out.

The inventor of the present application has not found any similar solution by search of many patent databases throughout the world. In addition, there is no any technical suggestion to combine the car safety device and car camera together.

To overcome the above drawbacks as existed in prior art devices, the inventor of the present application has made deep research and development and finally puts forth the present invention.

### SUMMARY OF THE INVENTION

One object of the invention is to provide a car video recorder which can record the events happened during the entire driving period and may help to find out the thief when the car is thieved, thus making the car have the function of determining intelligently the intruder and recording the whole criminal commitment. In addition, the procedure data can be transferred safely and reliably.

To achieve the above object, the following technical solution is provided.

The car video recorder of the invention includes the following components:

A human body sensing device for generating a first signal when a person gets close to the device;

An acceleration sensor for generating a second signal when it detects that an action is imposed on a car;

A camera device for real time video recording;

A control unit which detects whether the car starts; in case that the car flames out, if the control unit receives the first or second signal and the signal meets a predefined condition, then the control unit drives the camera device to automatically perform human body detection and human face recognition; after successful recognition, the control unit stores camera data as special data; and

A memory at least including a first partition for storage of the special data therein.

When a start status of the car is detected, the control unit will determine whether there exists the second signal meeting the predefined condition; if yes, then the camera data will be stored into the first partition of the memory as the special data; and if no, the camera data will be stored into a second partition of the memory as normal data.

The recorder further includes a first communication module which transfers wirelessly the special data to a remote server via a first communication network.

The recorder further includes a second communication module which transfers wirelessly the special data to a remote server via a second communication network.

The control unit selects the first communication module for transfer of the special data, and when transfer realized by the first communication module fails, the control unit selects the second communication module for transfer of the special data.

The first and second communication modules employ any one of the following communication networks: WiFi, WCDMA, CDMA2000, TD-SCDMA and GSM.

The first partition is set as hidden partition and is encrypted.

The predefined condition to be satisfied by the first signal includes at least one of the following conditions: duration of the first signal ranges from 2 seconds to 5 minutes; the first signal waveform matches with the waveform stored in advance into the memory; and the strength of the first signal is larger than predefined nominal amplitude.

The predefined condition to be met by the second signal is when the car is in flameout status, the acceleration value represented by the second signal should be no less than 0.1 g, wherein g=9.8 m/second.

The predefined condition to be met by the second signal is when the car is in start status, the acceleration value represented by the second signal should be no less than 2 g, wherein g=9.8 m/second.

The human body sensing device is an infrared sensor or microwave sensor.

The recorder further includes a video output interface connected electronically with the control unit for outputting the normal data stored in the second partition of the memory.

Compared with prior art, the invention has the following advantages.

At first, the acceleration sensor and human body sensing device are employed to accomplish human body detection and human face recognition, and the recognition result is recorded by video. As such, the face motion of the illegal intruder is recorded into the memory. As a result, when the car is thieved and it comes the time to find the lost car, it ma help to find the responsible party by reading the data stored in the memory.

Secondly, the signal generated by the acceleration sensor may be analyzed when the car is started such that it can determine whether the car operates normally (abnormal urgent braking will be believed to happen when the acceleration is larger than 2 g), and scenes outside the car and inside the car during running period of the car are recorded and stored for later use.

Thirdly, the video data carrying human face pictures is stored independently into the first partition. The first partition is further protected by means such as encryption or hiding. The data stored into the first partition will not have influence on the data stored into the second partition, and vice versa. It will be difficult to format or delete the data stored in the first partition, thus effectively protecting the video data containing the human face pictures.

Furthermore, the data related to human face picture may be delivered to a remote server via the communication module. To avoid damage of the communication module by person, additional communication module may be added to form communication link backup mechanism. By this way, the data related to human face picture may be transferred to the remote server as soon as possible, hence facilitating knowledge of the car condition at an earlier stage.

In addition, static obstacles, tiny animals, raindrops and the like are strictly distinguished from the human body by setting determination conditions for the human body sensing device so as to correctly identify the surrounding environment. The recorder will start related procedure only if the human body is approaching the car. By this manner, the comprehensive efficiency and recording accuracy of the recorder are improved and the lifespan of the recorder is also extended.

### BRIEF DESCRIPTION OF THE DRAWINGS

FIG. 1 shows a principle block diagram of a car video recorder of the present invention.

### DETAILED DESCRIPTION OF THE INVENTION

Various embodiments of the invention will be described below in further detail with reference to the accompanying drawings.

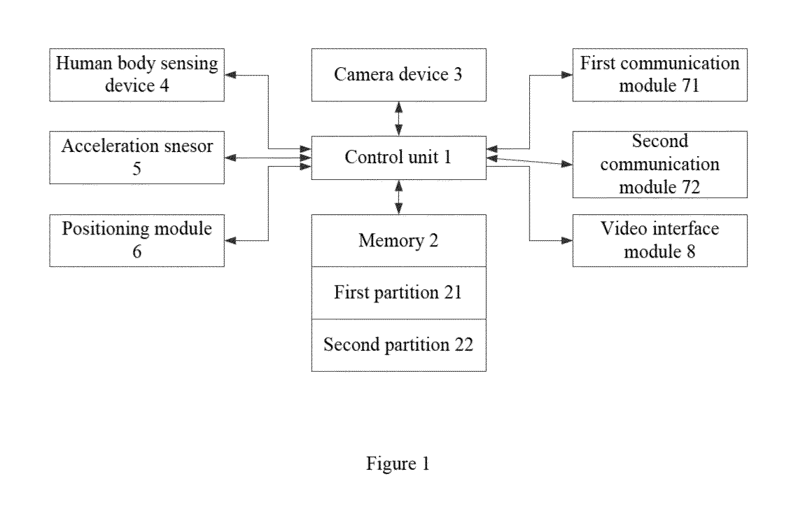

Reference is made to FIG. 1. According to the invention, a car video recorder includes a human body sensing device 4, an acceleration sensor 5, a camera device 3, a memory 2, a positioning module 6, a video interface module 8, two communication modules 71 and 72, and a control unit 1 for central control of the above components.

The human body sensing device 4 may employ a microwave sensor or infrared sensor and in this embodiment, the former is used. The microwave signal transmitted by the microwave sensor may be absorbed or reflected by an object. The microwave signal may be received by a receiving antenna and transformed into electrical signal and finally be processed by a measuring circuit, thus realizing detection of the microwave signal. The microwave signal detected may represent the strength (amplitude) and duration of the microwave signal obstructed by a specific object and eventually has specific waveform. These parameters represented by the microwave signal are utilized by the invention to determine whether there is unauthorized user performing intrusion near the car or inside the car. The detected signal is sent as a first signal to the control unit 1 and be handled by the same.

The acceleration sensor 5 is electronic equipment capable of measuring acceleration. Like earth gravity, the acceleration represents the force applied onto an object during the acceleration process. The acceleration may be a constant unit, for example the earth gravity is constantly 9.8 m/s. In other cases, the acceleration may be a variable parameter. There are two kinds of accelerometers one of which is angular accelerometer that is improved upon gyroscope (angular velocity sensor), while the other one of which is linear accelerometer. In the present invention, the acceleration signal detected by the acceleration sensor 5 is used as a second signal representing the value of the acceleration. The second signal is sent to the control unit 1 to be further processed thereby.

Working principles and implementation of the microwave sensor and acceleration sensor 5 is well known in the art and accordingly, description thereof is omitted herefrom so as not to obscure the invention.

The camera device 3 may be a conventional digital camera capable of taking photos. The camera device 3 may be controlled by control signal of the control unit 1 so as to take photos or videos. In addition, the camera device 3 may automatically detect human body and recognize human face. These detection and recognition techniques are also well known in the art and therefore, description thereof is omitted.

The memory 2 is divided physically or logically into two partitions. The first partition 21 is set as hidden and encrypted partition of which the data can only be accessed through dedicated third party software. Alternatively, the first partition may be set as only hidden partition or encrypted partition. Though the first partition is hidden, the control unit 1 and third party dedicated software may also have the access to it. However, other operating systems are unable to access it. When encryption is performed to the first partition 21, data stored in the first partition 21 may be encrypted, or the file allocation table (FAT) thereof may be encrypted. In this case, though the encrypted data may be displayed using some decryption means, the encrypted data may not be correctly read out deleted or modified without usage of the dedicated third party software. The second partition 22 may have a usual file format and may not be encrypted or hidden for conveniently reading out the data stored therein. The second partition is intended to store traffic report information recorded by the camera device when the car is in start status and positioning information recorded by the positioning module. The first partition 21 is used to store special data which will be discussed later, while the second partition 22 is used to store normal data. Both of the special data and normal data are video data obtained by the camera device 3. The difference between the two lies in that they respond to different predefined conditions. The camera data is a general concept which may include human face picture data obtained by recognition process of the camera device 3 and/or video data related to human motion and recorded by the camera device 3 after recognition of the human face.

The positioning module 6 may be a global positioning system, a Galileo positioning system, or Compass positioning system, for recording current positioning information and transmitting the information as signal to the control unit 1.

Under the control of the control unit 1, the video interface module 8 outputs the special data stored in the first partition 21 and/or normal data stored in the second partition 22 of the memory 2 to an external display so that the data is displayed, thus facilitating reading information stored in the memory 2.

In this embodiment of the invention, there are two communication modules, that is, modules 71 and 72. The communication modules 71 and 72 employ different communication systems and different remote servers (not shown), and perform communication by wireless manner. For example, the first communication module 71 may be connected to an internet via a WiFi local network, whereas the second communication module 72 may be connected to an internet via GSM, TD-SCDMA, WCDMA and CDMA2000. Both of the first and second communication modules 71 and 72 may be connected to the same remote server and transfer data between the module and server. The special data sent to the remote server by any one of the communication modules is finally stored into the remote server.

With the help of a certain computer program, the control unit 1 performs controls to the aforementioned components. The detailed control process is described as below.

Step 1: The car video recorder is powered, and initialization is performed to software. Under the control of the control unit 1, each functional module is diagnosed and at the same time, the whole system is positioned with the help of the positioning module 6, thus obtaining corresponding positioning information data. The camera device 3 begins to take video in real time and obtains the video data.

Step 2: The control unit 1 performs the car status diagnosis and determines whether the car is in start status. When it is determined through the ACC interface of the car that the car is in flame out status, then step 3 is performed: when it is determined that the car is in start status, then step 6 is performed.

Step 3: The human body sensing device 4 and acceleration sensor 5 begin to run under the control of the control unit 1. After that the human body sensing device 4 and acceleration sensor 5 perform the following sub-steps.

Step 3.1: A transmission antenna of a microwave sensor selected by the human body sensing device 4 transmits microwave signal to the surrounding space, and the microwave signal is received by a receiving antenna of the microwave sensor. A detection circuit inside the receiving antenna obtains the microwave signal (i.e., the first signal). The first signal is sent to the control unit 1.

Step 3.2: The acceleration sensor 5 detects the acceleration of the car and sends the electrical signal carrying the detection result information as a second signal to the control unit 1.

The control unit 1 obtains the first and second signals. Even in case that the control unit 1 enters standby state, it can still be activated by any one of the two signals and continues to work. The two signals are processed by the following two sub-steps.

Step 3.3: The first signal is defined to meet at least one of the following conditions: duration of the first signal ranges from 2 seconds to 5 minutes; the first signal waveform matches with the waveform stored in advance into the memory 2; and the strength of the first signal is larger than predefined nominal amplitude. The control unit 1 determines whether the above conditions are met. In this embodiment, only if all above predefined conditions are met, then the first signal truly represents a signal generated when there is a certain distance between a person and the car. When all of the above conditions are satisfied by the first signal, step 4.1 is performed. Otherwise, the control unit 1 enters standby state.

Step 3.4: The second signal is defined to meet the condition that the value of the acceleration represented by the second signal is no less than 0.1 g. Step 4.2 is performed in case that the above condition is met by the second signal. Otherwise, the control unit 1 enters standby state.

In step 3, the control unit 1 performs the signal detection with the assistance of the human body sensing device 4 and acceleration sensor 5. However, the sequence of the above steps is not limited to what has been described by now. More specifically, the control unit 1 detects the first signal and second signal individually. The subsequent sub-steps described above may be performed when any one signal meets corresponding predefined condition(s).

Step 4: When the control unit 1 knows that the first or second signal has met certain predefined conditions in the previous step, the following sub-steps run.

Step 4.1: In case that the first signal meets corresponding predefined conditions, the control unit 1 will firstly send photo-taking instructions to the camera device 3: after receiving the instructions, automatic human body recognition and human face recognition program built in the camera device 3 will focalize and recognize the human face; photos will be taken after finishing of the recognition, thus generating human face picture data and/or, the control unit 1 sends video-taking instructions to the camera device 3 such that the camera device 3 automatically performs human body detection and human face recognition and then focalizes the human face and takes video, thereby generating video data both human face picture data and video data are camera data at the time the camera device 3 takes photos or video, the control unit 1 also determines whether there exists the second signal satisfied the conditions set forth in step 3.4; in case that the camera device 3 successfully recognizes the human body or the control unit 1 detects existence of the second signal met the conditions set forth in step 3.4, the control unit 1 will drive the memory 2 to perform read-write operation to the first partition 21, and any one or both of the communication modules will be activated to establish connection with the remote server for data transfer.

Step 4.2: In case that the second signal meets corresponding predefined conditions, the control unit 1 will send photo-taking instructions to the camera device 3; after receiving the instructions, automatic human body recognition and human face recognition program built in the camera device 3 will focalize and recognize the human face; photos will be taken after finishing of the recognition, thus generating human face picture data; and/or, the control unit 1 sends video-taking instructions to the camera device 3 to take video, thereby generating video data, both human face picture data and video data are camera data; at the time the camera device 3 takes photos or video, the control unit 1 also drive the memory 2 to perform read-write operation to the first partition 21, and any one or both of the communication modules will be activated to establish connection with the remote server for data transfer.

Any one of the above steps 4.1 and 4.2 may be followed by step 5.

Step 5: After obtaining the camera data, the control unit 1 will store the camera data as special data into the first partition 21 of the memory 2; and at the same time, the activated first communication module 71 performs the data transfer to synchronously transferring the special data to the remote sever such the data is stored there in. In case that the data transfer performed by the first communication module 71 fails, the control unit 1 will start the second communication module 72 to transfer the special data in real time. By this way, the first and second communication modules form a mutual backup mechanism. When one communication module is damaged artificially, the rest one module located in hidden place will work normally, thus ensuring reliable transfer of the special data.

It is noted that during the process of obtaining the camera data by the camera device 3, other relevant information such as positioning information, environment information (measured by a temperature sensor or pressure sensor connected with the control unit 1) may also be collected by the control unit 1 and stored into the first partition 21 and then sent to the remote server. The above information is stored and transferred by the same manner as the special data and accordingly, it can be regarded as other additional information formed by removing the camera data from the special data or from normal data. As a result, the description thereof is omitted.

Step 6: This step runs in the event that the car is detected to be started in step 2. In this event, the control unit 1 detects whether there is the second signal generated by the acceleration sensor 5 and satisfying certain predefined conditions. The purpose of detection of the second signal is to determine whether the car acceleration has significantly changed during travel process. Therefore, the predefined conditions that should be met by the second signal need to be modified adaptively. For example in this embodiment, when the acceleration value represented by the second signal is no less than 2 g, significant change of the car acceleration is determined to have occurred. In case that significant change of the acceleration occurs, it is determined that urgent event happens. At this time, read-write operation is performed to the first partition 21 of the memory 2 and the camera device 3 records video. The camera data recorded by the camera device 3 along with other positioning information data, environment information data and so on is stored as the special data into the first partition 21. As described above, the special data may also be delivered via the communication module to the remote server. On the contrary, if no significant change has happened to the acceleration, then the car operates in a default status. In this case, the control unit 1 only performs read-write operation to the second partition 22 of the memory 2, and camera data obtained by recording action of the camera device 3 along with positioning information data and environment information data is stored in the second partition 22 of the memory 2 as normal data for use as traffic data.

It is noted that the camera device 3 may be mounted on a panel by means of a holder. Alternatively, it can also be hidden into any place inside the car. One or more camera devices 3 may be used for facilitating recording of the required information (for example information related to traffic report, driver and man who opened the car door).

In summary, the car video recorder of the invention employs the microwave sensor and acceleration sensor 5 and camera device 3 cooperatively to realize the functions such as recognition of the human face taking photos and video of the human face and safety transfer of the camera data carrying information related to the human face. Accordingly, the recorder of the invention is a new product which meets the market requirement, and this new product will bring great commercial value.

Though various embodiments of the invention have been illustrated above, a person of ordinary skill in the art will understand that, variations and improvements made upon the illustrative embodiments fall within the scope of the invention, and the scope of the invention is only limited by the accompanying claims and their equivalents.

1. A car video recorder comprising:
a human body sensing device for generating a first signal when a person gets close to the device;
an acceleration sensor for generating a second signal when it detects that an action is imposed on a car;
a camera device for real time video recording;
a control unit which detects whether the car starts; in case that the car flames out, if the control unit receives the first or second signal and the signal meets a predefined condition, then the control unit drives the camera device to automatically perform human body detection and human face recognition; after successful recognition, the control unit stores camera data as special data; and
a memory at least including a first partition for storage of the special data therein.

2. The car video recorder according to claim 1, wherein when a start status of the car is detected, the control unit will determine whether there exists the second signal meeting the predefined condition; if yes, then the camera data will be stored into the first partition of the memory as the special data; and if no, the camera data will be stored into a second partition of the memory as normal data.

3. The car video recorder according to claim 2, wherein further comprising a first communication module which transfers wirelessly the special data to a remote server via a first communication network.

4. The car video recorder according to claim 3, wherein further comprising a second communication module which transfers wirelessly the special data to a remote server via a second communication network.

5. The car video recorder according to claim 4, wherein the control unit selects the first communication module for transfer of the special data, and when transfer realized by the first communication module fails, the control unit selects the second communication module for transfer of the special data.

6. The car video recorder according to claim 5, wherein the first and second communication modules employ any one of the following communication networks: WiFi, WCDMA, CDMA2000 TD-SCDMA and GSM.

7. The car video recorder according to claim 1, wherein the first partition is set as hidden partition.

8. The car video recorder according to claim 1, wherein the first partition is set as encrypted.

9. The car video recorder according to claim 1, wherein the predefined condition to be satisfied by the first signal includes at least one of the following conditions: duration of the first signal ranges from 2 seconds to 5 minutes; the first signal waveform matches with the waveform stored in advance into the memory; and the strength of the first signal is larger than predefined nominal amplitude.

10. The car video recorder according to claim 1, wherein the predefined condition to be met by the second signal is when the car is in flameout status, the acceleration value represented by the second signal should be no less than 0.1 g, wherein g=9.8 m/second.

11. The car video recorder according to claim 2, wherein the predefined condition to be met by the second signal is when the car is in start status, the acceleration value represented by the second signal should be no less than 2 g, wherein g=9.8 m/second.

12. The car video recorder according to claim 1, wherein the human body sensing device is an infrared sensor or microwave sensor.

13. The car video recorder according to claim 2, wherein the recorder further includes a video output interface connected electronically with the control unit for outputting the normal data stored in the second partition of the memory.
